(19) United States
(12) Patent Application Publication
(10) Pub. No.: US 2001/0054965 A1
(43) Pub. Date: Dec. 27, 2001

(54) Leak detection and shut-off system

(76) Inventors: Martin Blum, Osprey, FL (US); Joseph Skudrzyk, St. Louis, MO (US); A. H. Mendenhall, Mendham, NJ (US)

Correspondence Address: Paul M. Denk, 763 South New Ballas Rd., St. Louis, MO, 63141, US

(21) Appl. No.: 09/851,926

(22) Filed: May 10, 2001

Related U.S. Application Data
(60) Provisional application No. 60/206,337, filed on May 23, 2000.

(51) Int. Cl. G08B 21/00

(52) U.S. Cl. 340/605; 340/604; 340/603

(57) ABSTRACT

A leak detection and shut-off system designed to detect a liquid leak or excess moisture at key locations in a piping system. The system includes a wireless detector comprising a sensor and transmitter which sends a signal to a receiver. The receiver triggers a control board to activate the closing of a valve to stop the flow of the liquid into the internal system or a block of a closed system.

### CROSS REFERENCE TO RELATED APPLICATIONS

This relates to provisional application Ser. No. 60/206,337, filed May 23, 2000, entitled HYDRO ALERT, DETECTION AND SHUT-OFF SYSTEM and which is incorporated herein by reference.

### STATEMENT REGARDING FEDERALLY SPONSORED RESEARCH OR DEVELOPMENT

Not Applicable.

### BACKGROUND OF THE INVENTION

This invention relates to the need to have a specific means to detect and control breaks in liquid transmission pipes.

There are presently available on the market various detectors to determine if there has been a break and, therefore, an unwanted liquid leak or spill of liquid in various areas. These type of detectors do not, however, cause the leak or the break to cease to exist. Take, for example, in a home where there is a break in a water pipe during a very cold spell and the owners are away on a winter vacation. They have one of the detectors which puts forth an alarm similar to a smoke alarm. But, there is no one there to react to the leaking water. Therefore, the water continues to flow doing much damage to the home.

Even if a liquid or moisture detector is hooked up to one of the those controlled services (most are not) it would take some time for a response to happen and considerable damage could be done by the leaking water.

Even in an industrial environment, there is a need for moisture detector systems for in a remote location of a plant. A pipe can break and cause significant damage.

Pipes carrying liquid are subject to breakage from freezing, poor maintenance, improper installation, aging, rust, and vandalism. It is possible to detect such breakage, but these systems do not cause the leak to stop. There is a need not only to detect the breakage, but to have the flow of the liquid stopped, and to stop quickly, to prevent damage to the surrounding areas from the leaking liquid.

### SUMMARY OF THE INVENTION

The object and purpose of this invention is to provide an economical system to detect breaks in liquid pipes and to cause the leaks to be stopped quickly, thus reducing or eliminating damage to the area in the vicinity of the break.

Another object of this invention is to provide a means for industrial applications to detect and cause to shut off leaks or excess moisture in conveyance of liquids.

A further object of this invention is to have said detector and shut-off accomplished by wireless remote application to eliminate the costly installation of wire controlled means. In accordance with the objects and purposes of the invention, there is provided a process whereby liquid or moisture detectors are installed at various key locations in, on or near the piping system. These detectors contain a water or moisture sensor and a transmitter. The combination of the moisture sensor and the transmitter provides the elements to send a signal to a receiver that a leak has occurred. Once a leak is detected, a receiver sends a signal to a control board. This control board is hard wired to a solenoid switch on shut off valve. The valve, with its solenoid switch, is placed at a location in the piping system where it is deemed most appropriate to have the liquid cease to flow. For example, in a home, the logical location would be at the point where the water comes into the house from the outside source. In an industrial application, shut off valves would be located at various places in a system that is set up in blocks or segments. The control panel is hard wired through a transformer, then to a power supply. The power supply could have a battery back-up in case of power failure. Additionally, an alarm could be added as well as having the system hooked up to one of these central alarm companies.

### BRIEF DESCRIPTION OF THE DRAWING

FIG. 1 is a schematic of the hydro alert, detector and shut-off system of this invention installed in a house adjacent a piping system.

FIG. 2 is a block diagram of the hydro alert, detector and shut-off system.

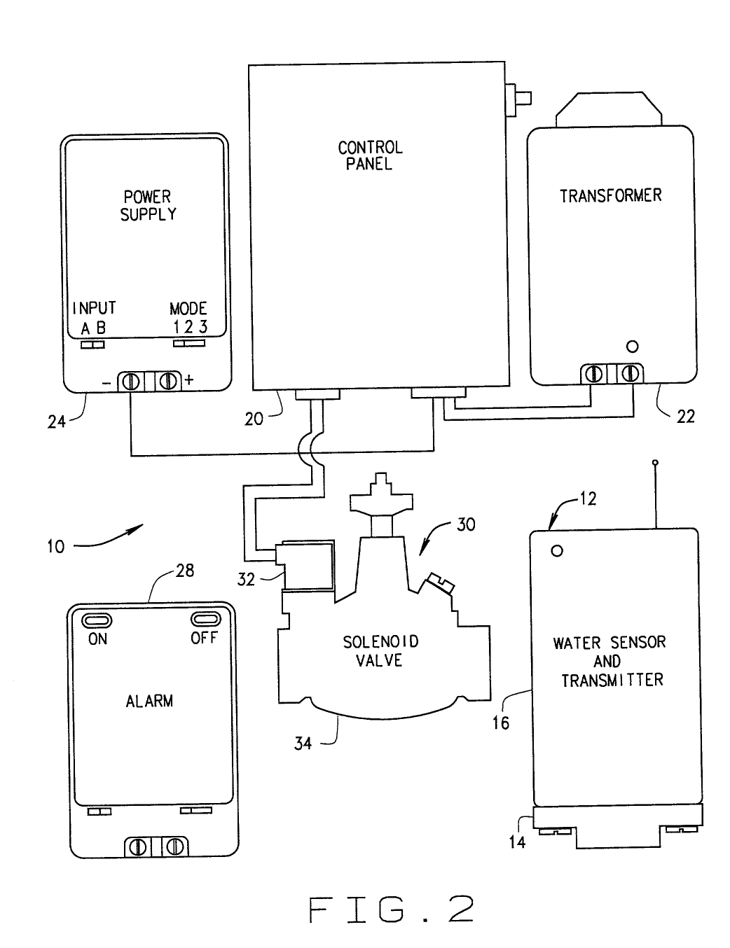

### DETAILED DESCRIPTION OF THE INVENTION

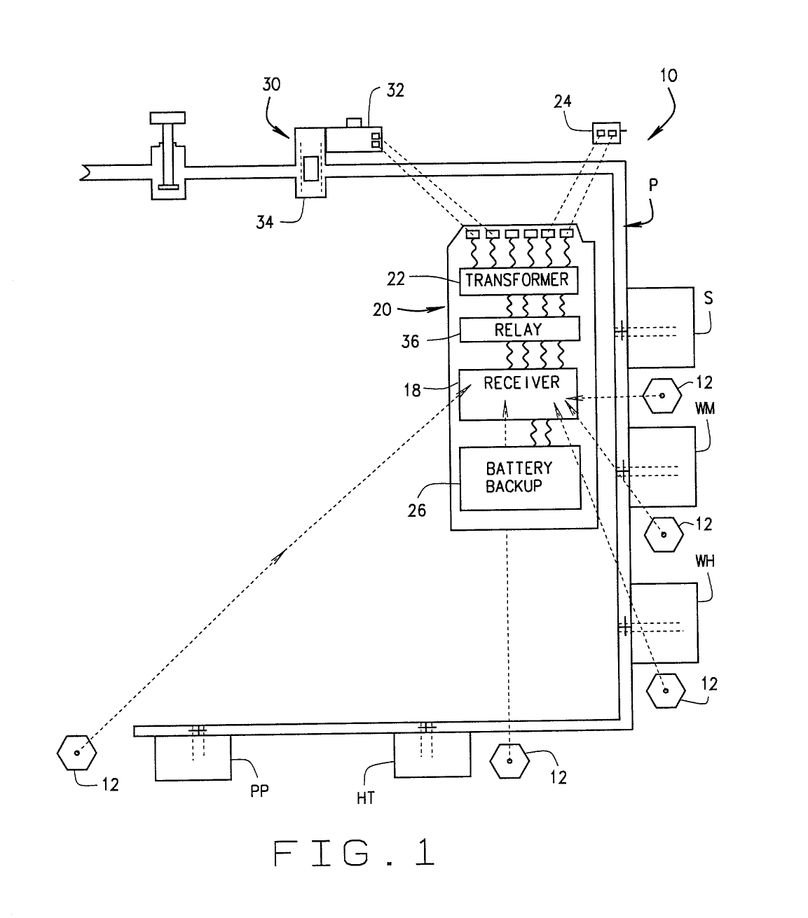

A leak detection and shut off system 10 includes a plurality of wireless detectors 12 placed at key locations in, on or near a piping system P to detect the presence of moisture. For example, in FIG. 1, which might be a basement of a home, detectors 12 are placed near a water heater WH, a washing machine WM, and a sink S. Additional wireless detectors are shown to be placed by a pool pump PP and a water system for a hot tub HT. The detectors 12 can include a plug wire to be plugged into the electrical system of a building. However, the detectors 12 are preferably battery powered. This provides more flexibility in the placement of the detectors around the piping system P. The detectors 12 contain a water or moisture sensor 14, such as a GRI P/N 12800 sensor available from Visonic, Ltd., of Tel Aviv, Israel, and a transmitter 16, such as a WT 101A transmitter, also available from Visonic Ltd. The sensor 14 and transmitter 16 are preferably combined together, such that the output of the sensor is connected directly to the input to the transmitter. Thus, the combination of the moisture sensor and the transmitter provides the elements to send a signal indicative of a leak when the sensor 14 detects moisture.

A receiver 18, such as a WR 200, available from Visonic Ltd., receives the signal from the detector 12. The receiver 18 is preferably part of control board 20, such as a control board made by Missouri Digital Electronics, Inc. The control board 20 includes a transformer 22 which is connected to 120V power supply 24. A battery back-up 26 can be incorporated into the control board 20 in case of power failure. Additionally, an alarm 28 could be added as well. The alarm 28 can be operated to sound an audible alarm when a leak is detected, or it can be operated to notify a central alarm company.

A solenoid activated valve 30, such as a Superior Control Corp. Model 950 is positioned in the piping system P. The valve 24, with its solenoid switch 22, is placed at a location in the liquid piping system P where it is deemed most appropriate to have the liquid cease to flow. For example, in a home, the logical location would be at the point where the water comes into the house from the outside source. In an industrial application, the shut off valve would be located at various places in a system that is set up in blocks or segments. The valve 30 include an solenoid switch 32 and a valve 34.

When the receiver 18 receives the signal from the detector 12, the receiver generates a signal which is transmitted to the solenoid switch 32 through the control board 20 via a relay 36. The signal sent to the solenoid switch activates the switch to move the valve 34 from its opened position to its closed position, to stop the flow of liquid through the piping system. Thus there is almost immediate shut down of the piping system eliminating or greatly reducing the damage that can be caused by unwanted liquid escaping from the piping system.

Because the system 10, except for the control board 20, can be made from off-the-shelf items, it is very economical, and easy to install. The detector 12 (the sensor 14 and transmitter 16) which are housed together are merely turned on and placed in appropriate locations. The receiver 18, transformer 22 and control board 20 (housed together) are preferably located a few feet from where the shut-off valve 30 is placed in the piping system P and are hard wired to the 120V power supply 24. The hardest part is cutting the pipe and having the cut-off valve inserted. But, even this can be done by an accomplished “do it yourselfer” or, of course, a licensed plumber. A battery backup 26 can be provided on the control board in case of power failure. Also, the system can easily be hooked up to a central alarm system.

Variations or modifications in the hydro alert, detection and shut-off system may occur to those skilled in the art upon reviewing the summary of the invention, in addition to the its preferred embodiment. Such variations, if within the spirit of this invention, are intended to be encompassed within the scope of the disclosure provided herein.

We claim:

1. A leak detection and shut-off system comprising:
at least one moisture detector; said moisture detector including a sensor for sensing the presence of moisture and a transmitter; said sensor generating a sensor signal when moisture is sensed; said transmitter receiving said sensor signal, and, in response thereto, generating a transmitted signal indicative of the detection of moisture;
a receiver remote from said detector; said receiver receiving said transmitted signal and generating a shut-off signal in response to said transmitted signal; and
a solenoid activated valve having a solenoid switch and a valve element; said valve element being movable between an opened position and a closed position in response to activation and deactivation of the solenoid switch; the solenoid of said valve receiving said shut-off signal from said receiver, and in response thereto, moving said valve from its open position to its closed position.

2. The system of claim 1 wherein the at least on moisture detector is a wireless detector.

3. In a piping system comprising piping through which liquid passes and a plurality of appliances which use the liquid; the improvement comprising a leak detection and shut-off system comprising:
at least one moisture detector positioned adjacent said piping at a desired position along said piping; said moisture detector including a sensor for sensing the presence of moisture and a transmitter; said sensor generating a sensor signal when moisture is sensed; said transmitter receiving said sensor signal, and, in response thereto, generating a transmitted signal indicative of the detection of moisture;
a receiver remote from said detector; said receiver receiving said transmitted signal and generating a shut-off signal in response to said transmitted signal; and
a solenoid activated valve positioned near a start of said piping system and having a solenoid switch and a valve element; said valve element being movable between an opened position and a closed position in response to activation and deactivation of the solenoid switch; the solenoid of said valve receiving said shut-off signal from said receiver, and in response thereto, moving said valve from its open position to its closed position.

4. The improvement of claim 3 wherein the leak detection and shut-off system further includes an alarm to notify personnel of a leak.
